(19) United States
(12) Patent Application Publication
(10) Pub. No.: US 2009/0320061 A1
(43) Pub. Date: Dec. 24, 2009

(54) Advertising Based on Keywords in Media Content

(75) Inventors: Bradley R. Pettit, Los Gatos, CA (US); Eric R. Soldan, Saratoga, CA (US); Nicolae Surpatanu, San Jose, CA (US); James A. Baldwin, Redwood City, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/141,924

(22) Filed: Jun. 19, 2008

(51) Int. Cl. H04N 7/025

(52) U.S. Cl. 725/34

(57) ABSTRACT

In accordance with one or more aspects, a trigger including both a criteria portion and a payload portion is accessed, the criteria portion identifying one or more criteria that includes a keyword, and the payload portion identifying one or more actions for presenting advertising content. Data corresponding to media content being presented is also accessed, and a check is made as to whether the data satisfies the one or more criteria. The one or more actions are performed in response to the data satisfying the one or more criteria. The trigger associating the advertising content with the keyword can be received in exchange for compensation.

### BACKGROUND

Television advertising has traditionally followed an approach in which commercial segments are interspersed between program segments. Advertisements are restricted to being included in these commercial segments, and typically must be inserted into these commercial segments prior to being broadcast to users' televisions. Accordingly, while this type of advertising can be effective, it can also be problematic because of the restrictions on the manner and timing of delivering advertisements to users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects of the advertising based on keywords in media content, compensation is received in exchange for associating advertising content with a keyword. A trigger corresponding to the keyword is obtained, the trigger identifying both the keyword and one or more actions to be performed for presenting the advertising content. The trigger is downloaded to one or more consumer devices so that each of the one or more consumer devices can present the advertising content in response to the keyword occurring in media content being presented by the consumer device.

In accordance with one or more aspects of the advertising based on keywords in media content, a trigger including both a criteria portion and a payload portion is accessed, the criteria portion identifying one or more criteria that includes a keyword, and the payload portion identifying one or more actions for presenting advertising content. Data corresponding to media content being presented is also accessed, and a check is made as to whether the data satisfies the one or more criteria. The one or more actions are performed in response to the data satisfying the one or more criteria.

In accordance with one or more aspects of the advertising based on keywords in media content, a device includes a trigger store and a monitor module. The trigger store is to store multiple triggers, each of the multiple triggers comprising a criteria portion and a payload portion. The criteria portion identifies one or more criteria including a keyword, and the payload portion identifies one or more actions for presenting advertising content. The monitor module is to monitor data corresponding to media content being presented and detect when the data satisfies the one or more criteria of one or more of the multiple triggers.

### BRIEF DESCRIPTION OF THE DRAWINGS

The same numbers are used throughout the drawings to reference like features.

FIG. 1 illustrates an example consumer device implementing the advertising based on keywords in media content in accordance with one or more embodiments.

FIG. 2 illustrates an example trigger that can be used with the advertising based on keywords in media content in accordance with one or more embodiments.

FIG. 3 is a flowchart illustrating an example process for advertising based on keywords in media content in accordance with one or more embodiments.

FIG. 4 is a flowchart illustrating an example process for advertising based on keywords in media content in accordance with one or more embodiments.

FIG. 5 illustrates an example system in which one or more embodiments of advertising based on keywords in media content can be implemented.

FIG. 6 illustrates various components of an example consumer device that can implement one or more embodiments of advertising based on keywords in media content.

FIG. 7 illustrates an example entertainment and information system in which one or more embodiments of advertising based on keywords in media content can be implemented.

### DETAILED DESCRIPTION

Advertising based on keywords in media content is discussed herein. A trigger is generated including both a criteria portion and a payload portion. The payload portion includes one or more actions to be performed for presenting advertising content. The criteria portion includes one or more criteria that are to be satisfied in order for the one or more actions to be performed. The one or more criteria includes one or more keywords that can be sold in exchange for associating advertising content with the one or more keywords. Accordingly, when these one or more keywords occur in media content being presented, the associated advertising content can also be presented.

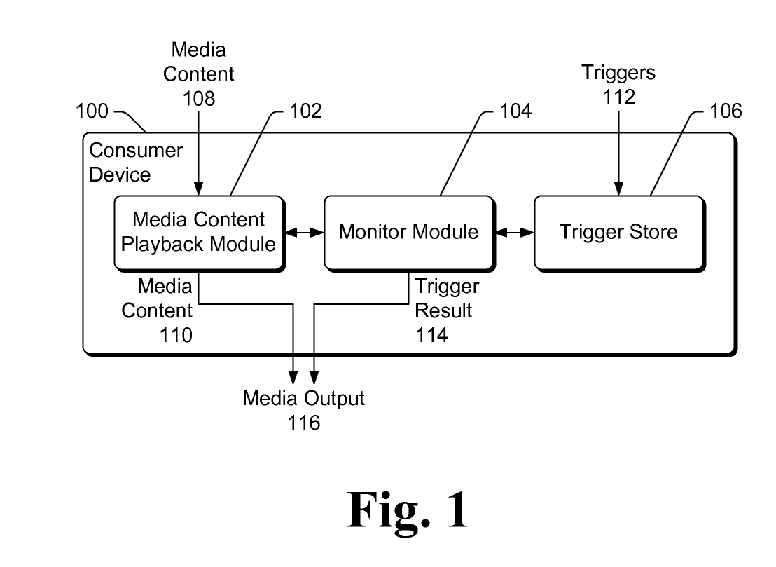

FIG. 1 illustrates an example consumer device 100 implementing the advertising based on keywords in media content in accordance with one or more embodiments. Consumer device 100 can be any of a variety of devices that output video for display. For example, consumer device 100 can be a computer, such as a desktop computer, server computer, a mobile station, an entertainment appliance, a set-top box communicatively coupled to a display device, a video playback device (e.g., digital video recorder (DVR), digital versatile disk (DVD) player, etc.), a television, a cell or other wireless phone, a game console, an automotive PC, and so forth. Thus, consumer device 100 can range from full resource devices with substantial memory and processor resources (e.g., personal computers, game consoles, etc.) to a low-resource device with limited memory and/or processing resources (e.g., traditional set-top boxes, hand-held game consoles, DVD players, etc.).

Consumer device 100 includes a media content playback module 102, a monitor module 104, and a trigger store 106. Media content refers to one or more of a variety of different types of content that can be played back to a user. Oftentimes media content is audio/video content (e.g., particular programs such as movies, sitcoms, commercials, news broadcasts, documentaries, sporting events, and so forth). Alternatively, media content can be only one type of content (e.g., just audio content, just video content, etc.), or can be other types of content (e.g., images, text, and so forth).

Media content playback module 102 receives media content 108 and outputs media content 110. Media content playback module 102 converts media content 108 into a format that can be played back (e.g., displayed by a display device, played back by speakers, etc.) and outputs the converted media content as media content 110. Media content playback module 102 can also receive input from a user (e.g., via a remote control device) or other component or module of device 100 to control the output of media content 110, such as to pause playback of the content, select particular media content for playback, fast forward or rewind through the media content, and so forth.

Media content 110, along with trigger result 114 as discussed in more detail below, are output by consumer device 100 as media output 116. In one or more embodiments, consumer device 100 plays back media output 116 (e.g., displays video content, plays back audio content, and so forth). In other embodiments consumer device 100 generates one or more signals based on media content 108 and/or trigger result 114 that is output to one or more other devices (e.g., televisions, projectors, speakers, etc.) which in turn present media output 116.

Media content 108 can be received from a variety of different sources. These sources can be local sources, such as a hard disk or a DVD that is inserted into, coupled to, or included as part of consumer device 100. These sources can also be remote sources, such as one or more remote servers or other devices making content 108 available to consumer device 100. Remote sources can make content 108 available over a variety of different types of networks, such as one or more of the Internet, a wide area network (WAN), a local area network (LAN), a wireless network, a telephone network, an intranet, and so forth.

In one or more embodiments media content 108 also includes metadata. The metadata can be included as part of (e.g., embedded in) other types of content (e.g., included in a vertical blanking interval (VBI) of video content, included in a packet header, and so forth). Alternatively, this metadata can be separate from other types of content, such as being included in a separate stream or channel from the audio, video, and/or other types of content. This metadata included in media content 108 is associated with, and describes, the audio, video, and/or other types of content in media content 108. Examples of such metadata include closed captioning data that is a text version of the audio content included in media content 108, teletext data corresponding to media content 108, song or program title information corresponding to media content 108, and so forth.

Trigger store 106 receives and stores triggers 112. Triggers 112 can be received from a variety of different sources. Analogous to media content 108, these sources can be local sources or remote sources making triggers 112 available over a variety of different types of networks. By way of example, triggers 112 can be received with media content (e.g., embedded therein, as part of a separate stream, in metadata of the media content, etc.), can be received with programming guide data, can be received via a separate communication with a trigger source, and so forth.

Each trigger 112 includes a payload portion identifying one or more actions to be performed for presenting advertising content, and a criteria portion identifying one or more criteria that are to be satisfied in order for the one or more actions to be performed. Trigger store 106 can be implemented as part of consumer device 100, or alternatively can be implemented on a removable storage device (e.g., optical disk, flash memory, etc.) or on a remote storage device (e.g., a server computer, other consumer device, etc.).

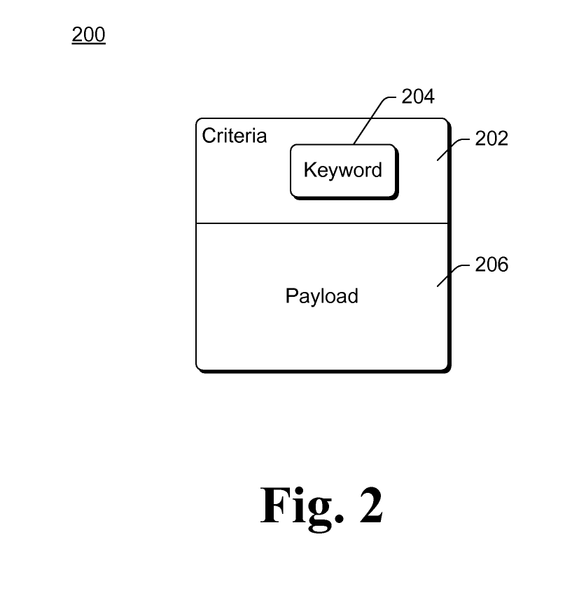

FIG. 2 illustrates an example trigger 200 that can be used with the advertising based on keywords in media content in accordance with one or more embodiments. Trigger 200 includes a criteria portion 202 including a keyword 204, and a payload portion 206. In one or more embodiments, trigger 200 also includes a trigger identifier, although in other embodiments no such identifier is included.

Payload portion 206 identifies one or more actions to be performed for presenting advertising content. A variety of different actions can be included in payload portion 206. In one or more embodiments payload portion 206 includes one or more actions to display particular advertising content, although advertising content can alternatively be presented in other manners. The advertising content can be stored in different locations, such as at a known location (e.g., known to monitor module 104 of FIG. 1), at a location identified in payload portion 206, in payload portion 206 itself, in the media content (e.g., media content 108 of FIG. 1), and so forth. The one or more actions to be performed can include various other actions, such as retrieving the advertising content from a particular location, pausing playback of the media content (e.g., media content 108 of FIG. 1), and so forth. The advertising content can be a variety of different types of content, such as video content, audio content, text content, image content, combinations thereof, and so forth.

Additionally, the one or more actions identified in payload portion 206 can include data, a script or other instructions, or other information to be made available to an application when the criteria in criteria portion 202 is satisfied. This application can be monitor module 104 of FIG. 1, or alternatively another module or application. This application can be an already executing application, or alternatively an application that is executed in response to the criteria in criteria portion 202 being satisfied.

Alternatively, a variety of other actions can be included in payload portion 206. Examples of such actions include creation of a new trigger, an indication that the one or more actions in the payload portion of another trigger are to be performed, a duration for which the advertising content is to be presented, and so forth.

Criteria portion 202 identifies one or more criteria that are to be satisfied in order for the one or more actions in payload portion 206 to be performed. At least one of these one or more criteria is a keyword 204. Although only one keyword 204 is illustrated in criteria portion 202, it is to be appreciated that multiple keywords 204 can be included in criteria portion 202. Keyword 204 identifies particular text that may occur in media content (e.g., media content 108 of FIG. 1). This particular text can be, for example, letters, numbers, symbols, and so forth. Different words, phrases, and so forth can be included as a keyword 204. When that particular text occurs in the media content, the one or more actions in payload portion 206 are performed (assuming other criteria included in criteria portion 202 is also satisfied). Alternatively, keyword 204 can be represented in other manners other than text, such as one or more images, audio data, and so forth.

In addition to keyword 204, various other criteria can also be included in criteria portion 202. In one or more embodiments, this criteria includes an identifier of particular media content. This identifier can be, for example, a title or name of the particular media content, a summary or other description of the content, or some other identifier. When such criteria are included in criteria portion 202, the one or more actions in payload portion 206 are performed only when that particular identified media content is being presented.

In one or more other embodiments, criteria portion 202 includes a time range. This time range can be, for example, a range of seconds, minutes, hours, days, and so forth. During presentation of media content, a current time is maintained and/or accessed. This current time can be, for example, a system or device time maintained by the consumer device present in the media content. When such time range criteria are included in criteria portion 202, the one or more actions in payload portion 206 are performed only when the current time is within the time range identified in criteria portion 202.

In one or more other embodiments, criteria portion 202 includes a channel identifier. This channel identifier can be, for example, a channel number, a call sign or other identifier of a broadcaster associated with the channel, and so forth. When such criteria are included in criteria portion 202, the one or more actions in payload portion 206 are performed only when the media content on that identified channel is being presented and/or that identified channel is tuned to.

By way of example, assume that particular advertising content is an image of an automobile logo to be displayed overlaying at least a portion of the media content. Further assume that this automobile logo is to be displayed whenever the word “drive” occurs in the media content. In this example, criteria portion 202 would include a keyword “drive”, and payload portion 206 would identify the automobile logo to be displayed (e.g., the logo itself, a link to where the logo can be obtained, and so forth).

Returning to FIG. 1, monitor module 104 monitors media content 108 and/or playback module 102 to identify when the criteria of one or more triggers 112 are satisfied. Monitor module 104 can communicate with playback module 102 to identify the particular media content 110 being output by module 102 at any given time. Alternatively, monitor module 104 can receive media content 108 and monitor this received content directly rather than via playback module 102. Additional information regarding playback media content 100 can also be obtained from playback module 102, such as an identifier of a program being played back, an identifier of a channel tuned to, and so forth.

In one or more embodiments, monitor module 104 monitors the metadata of media content 108. In such embodiments, whenever a keyword in a trigger occurs in the metadata of the media content 110 being output then monitor module 104 determines that the keyword criteria of that trigger is satisfied. In other embodiments, monitor module 104 can monitor other types of content of media content 108. For example, monitor module 104 can convert (or communicate with another component or module to have converted) audio content of media content 108 into text in order to determine whether a keyword in a trigger occurs in the audio data of media content 108.

Additionally, although keywords are discussed herein primarily as being text, it is to be appreciated that keywords can be represented in other manners. For example, a keyword could be represented as an image. In such situations, monitor module 104 can monitor video content of media content 108, analyzing the video content and performing pattern matching to determine when the image that is the keyword occurs in the video content. By way of another example, a keyword could be represented as audio data. In such situations, monitor module 104 can monitor audio content of media content 108, analyzing the audio content to determine when the audio data that is the keyword occurs in the audio content.

In monitoring the metadata (or other types of media content 108), monitor module 104 monitors the media content 108 being played back and determines if and when the criteria are satisfied. One or more of the criteria, such as the keyword, are satisfied at a time when the indicated criteria occur. For example, assume a trigger includes a keyword “drive”, and that the word “drive” occurs in the media content 108 at a point 12 minutes and 43 seconds into the playback of the media content 108. In this example, the criteria of the keyword “drive” would not be satisfied until playback of the media content 108 is at the point 12 minutes and 43 seconds into the playback. At that point, if the other criteria (if any) of the trigger are satisfied, then the criteria of the trigger are satisfied; otherwise the trigger is not satisfied.

It should be noted that in one or more embodiments a duration can optionally be associated with the keyword. This duration can be included in the criteria portion of the trigger, can be a default value used by monitor module 104, or alternatively can be identified in other manners. This duration indicates how long after the occurrence of the keyword in the data of the media content 108 the keyword criteria is still satisfied. For example, if the duration is 5 seconds, following the example above the criteria of the keyword “drive” would be satisfied from the point 12 minutes and 43 seconds into playback of the media content 108 to the point 12 minutes and 48 seconds into playback of the media content 108.

It should also be noted that in one or more embodiments the data of media content 108 is available for analysis by monitor module 104 an amount of time (e.g., at least a few seconds) before it is played back by module 102. Accordingly, monitor module 104 can analyze the data of media content 108 prior to the media content being played back by module 102, allowing the one or more actions for presenting advertising content to be performed at approximately the same time, or alternatively an amount of time before, the keyword actually occurs in the media content 108. For example, if the keyword is “drive” and the one or more actions are to present an automotive logo as the advertising content, then the automotive logo can be displayed as the word “drive” is spoken by an actor or actress in the playback of media content 108, or an amount of time (e.g., two seconds) before the word “drive” is spoken in the playback of media content 108.

When monitor module 104 determines that the one or more criteria of a trigger 112 are satisfied, monitor module 104 performs the one or more actions for presenting advertising content identified in the payload portion of the trigger. In response to performing these one or more actions, monitor module 104 generates a trigger result 114 that is output by consumer device 100. Media content 110 and/or trigger result 114 are output by consumer device 100 as media output 116. Media content 110 and trigger result 114 can be output concurrently as media output 116 or alternatively separately as discussed in more detail below.

Trigger result 114 can be the output of a variety of different types of content, such as video content, image content, audio content, and so forth as discussed above. Trigger result 114 can be presented concurrently with presentation of media content 110. For example, trigger result 114 can be video content or an image that is displayed overlaid on media content 110, such as a small icon at the bottom of a display. These small icons can also be referred to as “bugs”. By way of another example, trigger result 114 can be audio content that is played back concurrently with media content 110. Alternatively, trigger result 114 can be presented separately from the presentation of media content 110. For example, playback of media content 110 can be paused while trigger result 114 is presented.

Additionally, it should be noted that in order to perform the one or more actions identified in the payload portion of a trigger, monitor module 104 may access one or more other devices. For example, monitor module 104 may access a remote device over a network to retrieve content to be displayed as trigger result 114. In one or more embodiments, monitor module 104 accesses a remote server over the Internet to retrieve one or more images or Web pages to be displayed as trigger result 114.

Alternatively, in one or more embodiments monitor module 104 invokes one or more other components or modules to generate the presentation of trigger result 114. For example, monitor module 104 can invoke a Web browser module, a remote device communication module (e.g., supporting RDP (Remote Desktop Protocol)), other applications that display or otherwise present advertising content, and so forth. Such other components or modules can be invoked in a variety of different manners, such as firing an event that is dispatched to the appropriate component or module by an event dispatcher, invoking an application programming interface (API) exposed by the component or module, and so forth.

Monitor module 104 can be implemented to monitor the data of media content 108 and compare it to triggers 112 in a variety of different manners. In one or more embodiments, monitor module 104 (or alternatively another component or module) generates trigger objects and session objects. A trigger object is generated for each trigger 112 and includes the criteria (including keywords) and actions to be performed from the criteria and payload portions of the trigger 112. A session object is also generated that describes the current media content session. The session object includes data of the media content (e.g., channel number via which the media content is being received, call sign of the channel via which the media content is being received, title of the programming that is distributed as the media content, and so forth). Metadata of the media content (or other types of data being monitored by module 104) is typically not included in this session object but rather is analyzed as it is received. Alternatively, this metadata or other type of data can be included in the session object.

Triggers 112 can be provisioned triggers and/or application-based triggers. A provisioned trigger refers to a trigger that is distributed to consumer device 100 by some remote device or component. This distribution is initiated by the remote device or component, and the provision triggers typically remain in trigger store 106 until they expire or are updated by the remote device or component. An application-based trigger refers to a trigger that is added to trigger store 106 by an application or module running on consumer device 100. Application-based triggers typically remain in trigger store 106 while the application is running, and are removed from trigger store 106 when the application stops running.

In one or more embodiments, all of the criteria included in the criteria portion of the trigger need to be satisfied in order for the one or more actions for presenting advertising content to be performed. Alternatively various logical operators, such as “AND” and “OR”, can be used in conjunction with the criteria to allow different combinations to be defined. For example, four different criteria could be listed, at least one of which is to be satisfied in order for the one or more actions for presenting advertising content to be performed. By way of another example, three different criteria could be listed, a particular one of which and either one (or both) of the other two is (are) to be satisfied in order for the one or more actions for presenting advertising content to be performed.

Additionally, it should be noted that criteria can be full-match or partial-match criteria. Full-match criteria indicates that the criteria is to match the data of the programming content exactly, whereas partial-match criteria indicates that the data of the programming is to include at least the partial-match criteria. For example, if the data of the programming were “Microsoft Corporation” and the criteria were “Corporation”, then the criteria would be a partial-match to the data of the programming but not a full-match. Whether criteria is full-match or partial-match can be inherent in the particular criteria, or identified in other manners such as including a flag or other value with the criteria indicating whether it is full-match or partial-match.

Furthermore, partial-match criteria can be a “starts-with” partial-match, an “anywhere” partial-match, or other type of partial-match. A starts-with partial-match indicates that the data of the programming is to start with the criteria, whereas an anywhere partial-match indicates that the criteria can be included anywhere in the data of the programming. For example, if the data of the programming were “Microsoft Corporation” and the criteria were “Corporation”, then the criteria would be an anywhere partial-match to the data of the programming but not a starts-with partial-match. Other types of partial matches can also be defined using regular expressions. For example, quantifiers or wild cards can be used, such as “*” to indicate zero or more characters, “?” to indicate zero or one characters, and so forth. Whether partial-match criteria is starts-with or anywhere criteria, or alternatively other criteria, can be inherent in the particular criteria or can be identified in other manners such as including a flag or other value with the criteria indicating whether it is starts-with or anywhere.

In one or more embodiments, trigger result 114 is presented for a particular amount of time. The duration of the presentation of trigger result 114 can be the same for all triggers, or alternatively vary by trigger. In one or more embodiments, each trigger 112 includes as part of its payload portion an identifier of the duration of the presentation of trigger result 114 for that particular trigger. Alternatively, the duration can be identified in different manners. For example, monitor module 104 can be programmed or otherwise configured with an indication of the duration, media content 108 can identify durations for trigger results occurring during presentation of media content 108, and so forth.

Additionally, in one or more embodiments monitor module 104 performs the actions for presenting advertising content in a trigger once. After the actions have been performed once, monitor module 104 no longer performs the actions even though the criteria of the trigger may be satisfied. Alternatively, in other embodiments monitor module 104 can perform the actions for presenting advertising content in a trigger each time the criteria are satisfied. In such embodiments, monitor module 104 can restrict how frequently the actions can be performed. For example, even though the criteria may be satisfied every 30 seconds, monitor module 104 can restrict the actions to being performed no more than once every five minutes.

Such restrictions can be imposed by monitor module 104 in a variety of different manners. In one or more embodiments, a trigger 112 includes an indication of how frequently the actions can be performed. This indication can be included, for example, in the payload portion of the trigger. When the criteria of a trigger are satisfied and the one or more actions performed, monitor module 104 obtains an indication of how frequently the one or more actions can be performed. This indication can indicate a time (e.g., 30 seconds, five minutes, once per day, etc.), in which case monitor module 104 does not perform the one or more actions until after that amount of time has elapsed. Monitor module 104 need not check whether the criteria of that trigger are satisfied until after that indicated frequency is passed. Alternatively, monitor module 104 may check whether the criteria of the trigger are satisfied, but not perform the one or more actions until after that indicated frequency is passed. Alternatively, this indication can be a count value (e.g., 5, 8, 12, 50, etc.), in which case monitor module 104 keeps track of how many times the one or more actions have been performed in response to the criteria being satisfied, and does not perform the one or more actions after the count value has been reached. This count value can optionally be reset at regular or irregular intervals (e.g., hourly, daily, each time a new program begins or a channel change occurs, and so forth).

It should be noted that conflict situations can arise where the criteria of multiple different triggers are satisfied concurrently. Such conflicts can be resolved in a variety of different manners. In one or more embodiments, each trigger includes a priority value and the conflict is resolved by performing the actions for the trigger with the higher priority value. In other embodiments, monitor module 104 can keep track of when the actions for presenting advertising content for the different triggers have been performed. In such embodiments, these conflicts can be resolved by performing the actions for the trigger that least recently had his actions performed. Alternatively, these conflicts can be resolved in other manners, such as random selection of a trigger, concurrent presentation of multiple triggers, selecting triggers according to some other criteria or rules, and so forth.

The advertising based on keywords in media content discussed herein allows for a variety of different advertising scenarios. Revenue or other compensation can be received in exchange for associating advertising content with a particular keyword. In response to receiving this revenue or other compensation a trigger can be generated or otherwise obtained having a payload portion that identifies the advertising content and a criteria portion that includes the particular keyword. In other words, particular keywords can be sold, allowing advertising content to be presented whenever the sold keywords occur in media content being presented.

Furthermore, different scenarios can allow for the same keyword to be sold to multiple different companies, individuals, or other entities. Different restrictions can be imposed for these different purchasers, optionally based on how much the purchasers have paid for the keyword. For example, the keyword “drive” can be sold to multiple different automotive manufacturers. Each of these manufacturers can have a different automotive logo as the advertising content associated with the keyword they have purchased. Additional criteria indicating how frequently their respective advertising contents are to be presented can be included in their respective triggers. So, as a specific example, a first manufacturer that paid more money can have its automotive logo displayed as advertising content once every five minutes when the keyword “drive” occurs in the media content. Meanwhile, a second manufacturer that paid less money than the first manufacturer can have its automotive logo displayed as advertising content once every seven minutes when the keyword “drive” appears in the same media content.

As discussed above, a variety of different criteria can be included in the criteria portion of a trigger. Table I lists example criteria that can be included in the criteria portion of a trigger in accordance with one or more embodiments. It is to be appreciated that Table I lists only example criteria; not all of the criteria in Table I need be used, or alternatively additional criteria can be included.

TABLE I

| Criteria | Description |
|---|---|
| Keyword | One or more keywords to occur in the media content. |
| Title | The title of a program that is included in the media content. |
| Episode | The episode of a program that is included in the media content. |
| Description | A description of a program that is included in the media content. |
| Actor List | One or more actors or actresses that appear in a program that is |
| | included in the media content. |
| Director | One or more directors of a program that is included in the media |
| | content. |
| Currently tuned | A call sign of the channel via which the media content is being |
| channel call sign | received. |
| Currently tuned | A number of the channel via which the media content is being received. |
| channel number | |
| DateTime | A beginning date and/or time for the trigger. This criteria is |
| Beginning | satisfied only if the current date and/or time is after the beginning |
| | date and/or time. |
| DateTime | An ending date and/or time for the trigger. This criteria is |
| Ending | satisfied only if the current date and/or time is before the ending |
| | date and/or time. |
| DateTime Expire | An expiration date and/or time for the trigger. This criteria is |
| | satisfied only if the current data and/or time is before the |
| | expiration date and/or time. The trigger can optionally be |
| | removed (e.g., by monitor module 104) after the expiration date |
| | and/or time. |
| Program-relative | A time value which is added to the program's beginning |
| Beginning Time | DateTime. If no time value is specified, then the program's |
| | beginning DateTime is used. This derived value is then used as |
| | the comparison criteria, comparing against the current DateTime |
| | value. This criteria is satisfied only if the current DateTime is |
| | greater than or equal to the derived value. |
| Program-relative | A time value which is added to the program's beginning |
| Ending Time | DateTime. If no time value is specified, then the program's |
| | ending DateTime is used. This derived value is then used as the |
| | comparison criteria, comparing against the current DateTime |
| | value. This criteria is satisfied only if the current DateTime is less |
| | than or equal to the derived value. |

Some example triggers are discussed in the following. It is to be appreciated that these are only examples, and that other formats and triggers can be used with the advertising based on keywords in media content discussed herein. One example trigger is:

[KEYWORD:drive],[EVENT:act1]

This example trigger indicates that the criteria is a keyword of “drive”, and when that criteria is satisfied then an action “act1” is to be performed. This action “act1” can be any of a variety of different actions for presenting advertising content as discussed above. Another example trigger is:

[KEYWORD:drive], [CHANNEL:274], [EVENT:someURL]

This example trigger indicates that the criteria are a keyword of “drive” on channel 274, and when those criteria are both satisfied then an action of presenting as advertising content the data at a particular location identified by “someURL” is to be performed.

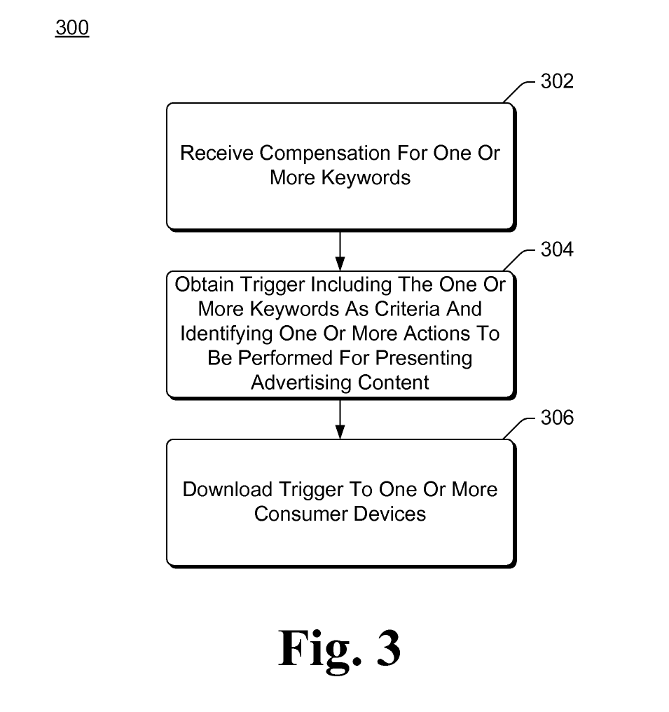

FIG. 3 is a flowchart illustrating an example process 300 for advertising based on keywords in media content in accordance with one or more embodiments. Process 300 is carried out by a device and can be implemented in software, firmware, hardware, or combinations thereof. Process 300 can be carried out by a consumer device, such as consumer device 100 of FIG. 1, or alternatively another device (e.g., a server computer). Process 300 is an example process for advertising based on keywords in media content; additional discussions of advertising based on keywords in media content are included herein with reference to different figures.

In process 300, compensation for one or more keywords is received (act 302). This compensation can be monetary or alternatively can take a variety of other forms, such as discounts, goods or services, agreements for particular branding or advertising in other products or locations, and so forth. This compensation is received in exchange for associating advertising content with the one or more keywords.

A trigger is also obtained (act 304). The trigger includes the one or more keywords as criteria and identifies one or more actions to be performed for presenting advertising content. The trigger can be retrieved from another component or device or alternatively can be generated including the appropriate criteria. Other criteria can optionally be included in a criteria portion of the trigger as discussed above. The one or more actions to be performed in presenting advertising content are identified in a payload portion of the trigger as discussed above.

The obtained trigger is downloaded to one or more consumer devices (act 306). Once at the consumer devices, the one or more actions for presenting advertising content included in the payload portion of the trigger can be performed at the consumer devices.

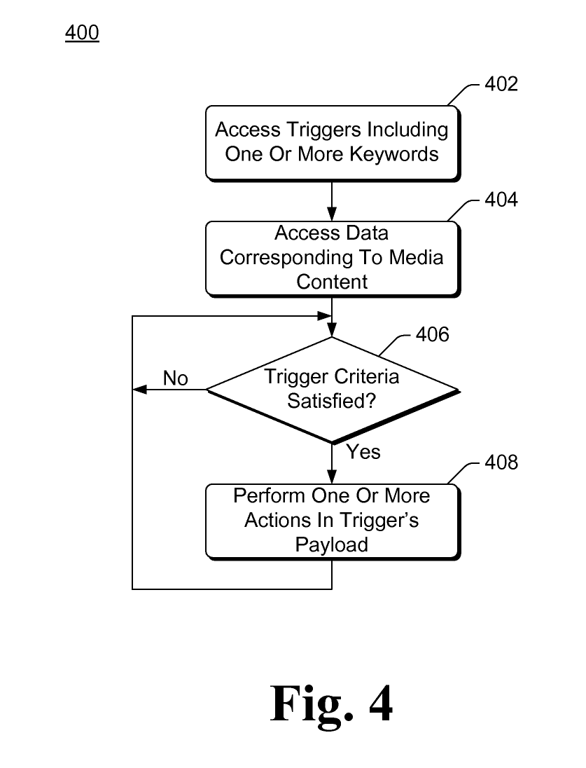

FIG. 4 is a flowchart illustrating an example process 400 for advertising based on keywords in media content in accordance with one or more embodiments. Process 400 is carried out by a device, such as consumer device 100 of FIG. 1, and can be implemented in software, firmware, hardware, or combinations thereof. Process 400 is an example process for advertising based on keywords in media content; additional discussions of advertising based on keywords in media content are included herein with reference to different figures.

In process 400, triggers including one or more keywords are accessed (act 402). Each trigger can be accessed in a variety of different manners, such as by retrieving the trigger from a trigger store as discussed above. Additionally, data corresponding to media content is accessed (act 404). This data corresponding to media content can include the media content itself (e.g., metadata, audio data, video data, and so forth) as well as other data describing the media content or its presentation (e.g., an identifier of the media content, a channel via which the media content is received, and so forth).

A check is then made as to whether the data corresponding to the media content satisfies the criteria of one of the triggers (act 406). This criteria includes at least one keyword and can also include other criteria as discussed above. This check is repeated until the criteria of one of the triggers is satisfied. When the criteria of one of the triggers is satisfied, the one or more actions included in a payload portion of that trigger are performed (act 408). These one or more actions include displaying or otherwise presenting advertising content, as discussed above. Process 400 then continues to check whether the data corresponding to the media content satisfies the criteria of one of the triggers (act 406).

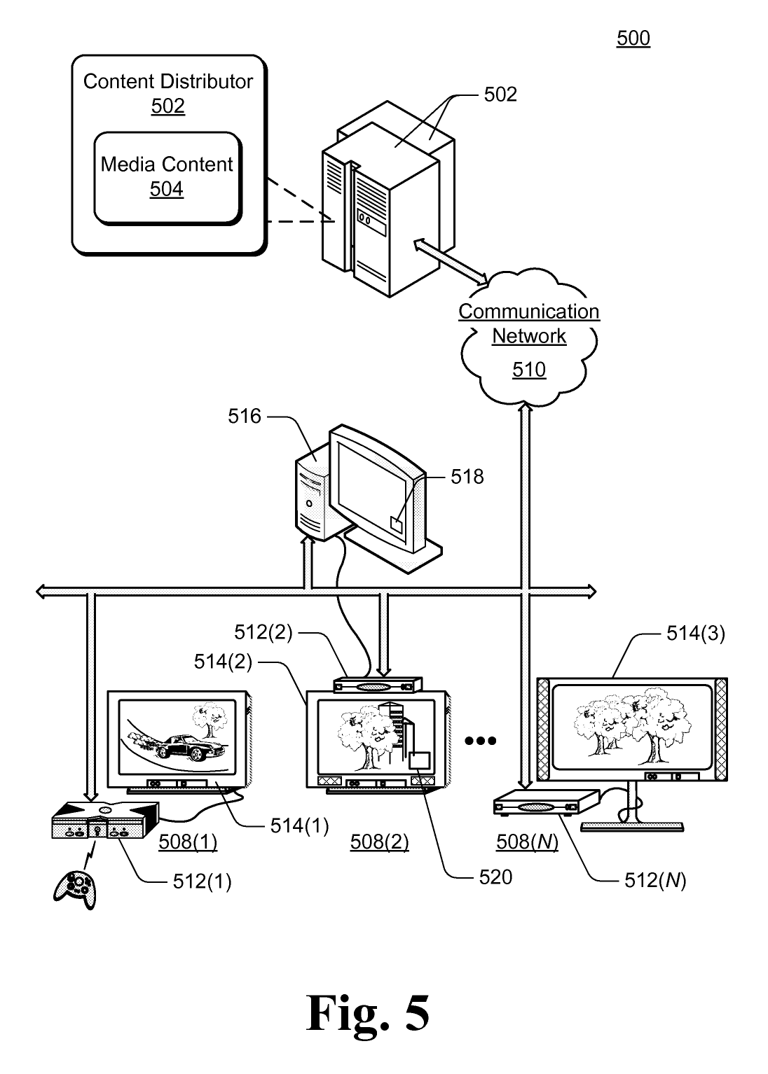

FIG. 5 illustrates an example system 500 in which one or more embodiments of advertising based on keywords in media content can be implemented. System 500 includes one or more content distributors 502 that communicate media content 504 to any number “N” of various television client systems 508(1-N) via a communication network 510. Client systems 508 can each be, for example, a different type (or alternatively the same types) of consumer device 100 of FIG. 1. Communication network 510 can be implemented to include an IP-based network that facilitates media content distribution and data communication between the content distributor(s) 502 and any number of television client devices.

Each of client systems 508(1-N) includes a respective television client device 512(1-N) and a respective display device 514(1-N), such as any type of television, monitor, LCD, projector, or similar television-based display system that renders audio, video, and/or image data. Any of client devices 512(1-N) can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device. Any of television client devices 512(1-N) may also be associated with a user (e.g., a person) and/or an entity that operates a client device such that a television client device describes logical clients that include users, software, and/or devices.

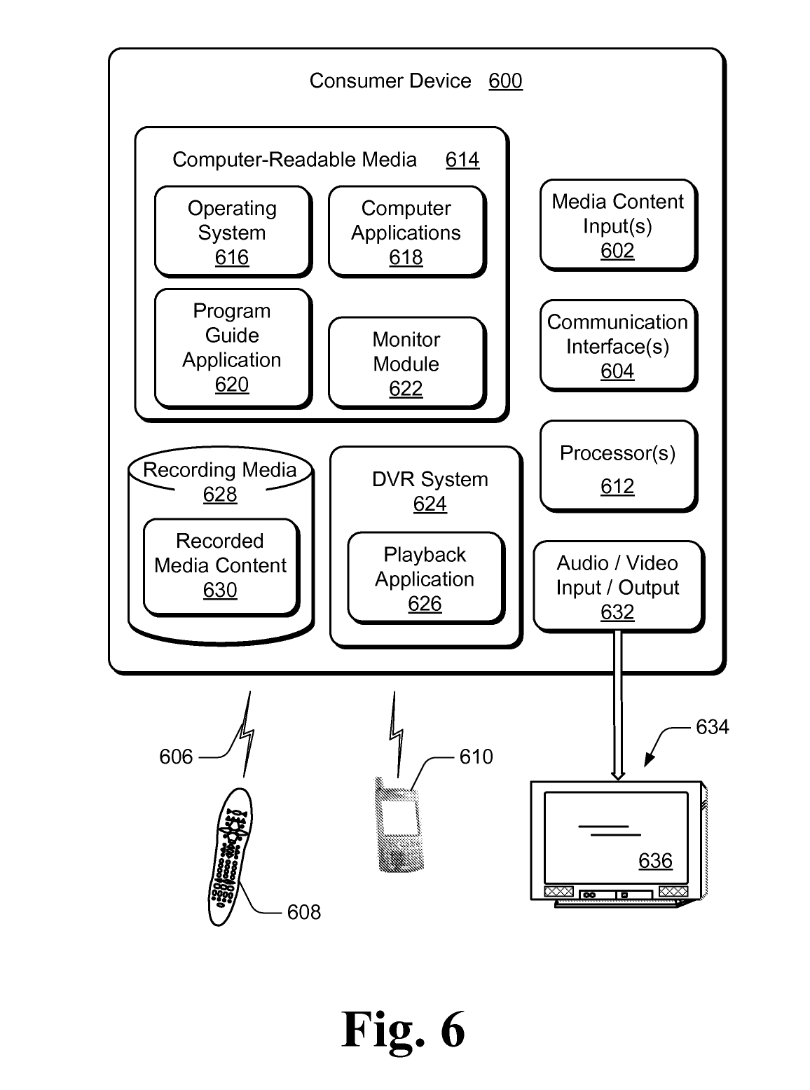

Any of television client devices 512(1-N) of the respective client systems 508(1-N) can be implemented with one or more processors, a communication module, memory components, a media content rendering system, and a monitor module and trigger store to implement embodiments of advertising based on keywords in media content. Additionally, each of television client devices 512(1-N) can be configured for communication with any number of different content distributors 502 to receive any type of media content 504 via the communication network 510. Further, any of the television client devices 512(1-N) can be implemented with any number and combination of differing components as further described with reference to the example client device shown in FIG. 6.

In this example, client device 512(2) is a television set-top box that is connected, or otherwise communicatively linked, to a computing device 516 that can be implemented to display advertising content 518. Alternatively, advertising content can be presented in other manners as discussed above. Computing device 516 can also be configured for communication with a content distributor 502 to receive the trigger (e.g., triggers 112 of FIG. 1) via the communication network 510.

FIG. 6 illustrates various components of an example consumer device 600 that can be implemented as any form of a computing, electronic, or television client device to implement one or more embodiments of advertising based on keywords in media content. For example, consumer device 600 can be implemented as consumer device 100 shown in FIG. 1, and/or as any of the client devices 512(1-N) of client systems 508(1-N) shown in FIG. 5. In various embodiments, consumer device 600 can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device.

Consumer device 600 includes one or more media content inputs 602 that may include Internet Protocol (IP) inputs over which streams of media content are received via an IP-based network. Consumer device 600 further includes communication interface(s) 604 that can be implemented as any one or more of a serial and/or parallel interface, a wireless interface, any type of network interface, a modem, and as any other type of communication interface. A wireless interface enables client device 600 to receive control input commands 606 and other information from an input device, such as from remote control device 608, a portable computing-based device (such as a cellular phone) 610, or from another infrared (IR), 802.11, Bluetooth, or similar RF input device.

A network interface provides a connection between consumer device 600 and a communication network by which other electronic and computing devices can communicate data with device 600. Similarly, a serial and/or parallel interface provides for data communication directly between client device 600 and the other electronic or computing devices. A modem facilitates client device 600 communication with other electronic and computing devices via a conventional telephone line, a DSL connection, cable, and/or other type of connection.

Consumer device 600 also includes one or more processors 612 (e.g., any of microprocessors, controllers, and the like) which process various computer-executable instructions to control the operation of device 600, to communicate with other electronic and computing devices, and to implement embodiments of advertising based on keywords in media content. Consumer device 600 can be implemented with computer-readable media 614, such as one or more memory components, examples of which include random access memory (RAM), nonvolatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer-readable media 614 provides data storage mechanisms to store various information and/or data such as software applications and any other types of information and data related to operational aspects of consumer device 600. For example, an operating system 616 and/or other computer applications 618 can be maintained as software applications with the computer-readable media 614 and executed on processor(s) 612 to implement embodiments of the advertising based on keywords in media content.

Consumer device 600 can also include a program guide application 620 that is implemented to process program guide data and generate program guides for display. A program guide enables a viewer to navigate through an onscreen display and locate various media content such as broadcast programs, recorded programs, video on-demand programs and movies, interactive game selections, network-based applications, and other media content of interest to the viewer. Consumer device 600 can also include a monitor module 622 (shown as a software module in this example) to implement various embodiments of advertising based on keywords in media content as described herein.

Consumer device 600 can also include a DVR system 624 with playback application 626, and recording media 628 to maintain recorded media content 630 that consumer device 600 receives and/or records. Further, consumer device 600 may access or receive additional recorded media content that is maintained with a remote data store (not shown). Consumer device 600 may also receive media content from a video on-demand server, or media content that is maintained at a broadcast center or content distributor that distributes the media content to subscriber sites and client devices. Playback application 626 is a video control application that can be implemented to control the playback of media content, the recorded media content 630, and/or other video on-demand media content, music, and any other audio, video, and/or image media content which can be rendered and/or displayed for viewing. Playback application 626 can be, for example, media content playback module 102 of FIG. 1.

Consumer device 600 also includes an audio and/or video output 632 that provides audio and/or video data to an audio rendering and/or display system 634. Audio rendering and/or display system 634 can include any devices that process, display, and/or otherwise render audio, video, and image data. Video signals and audio signals can be communicated from consumer device 600 to a display device 636 via an RF (radio frequency) link, S-video link, composite video link, component video link, DVI (digital video interface), analog audio connection, or other similar communication link. Alternatively, audio rendering and/or display system 634 can be implemented as integrated components of the example consumer device 600. Consumer device 600 along with the audio rendering and/or display system 634 is an example of a viewing system that can be implemented in a household viewing area for viewing television programs and/or receiving other television media content.

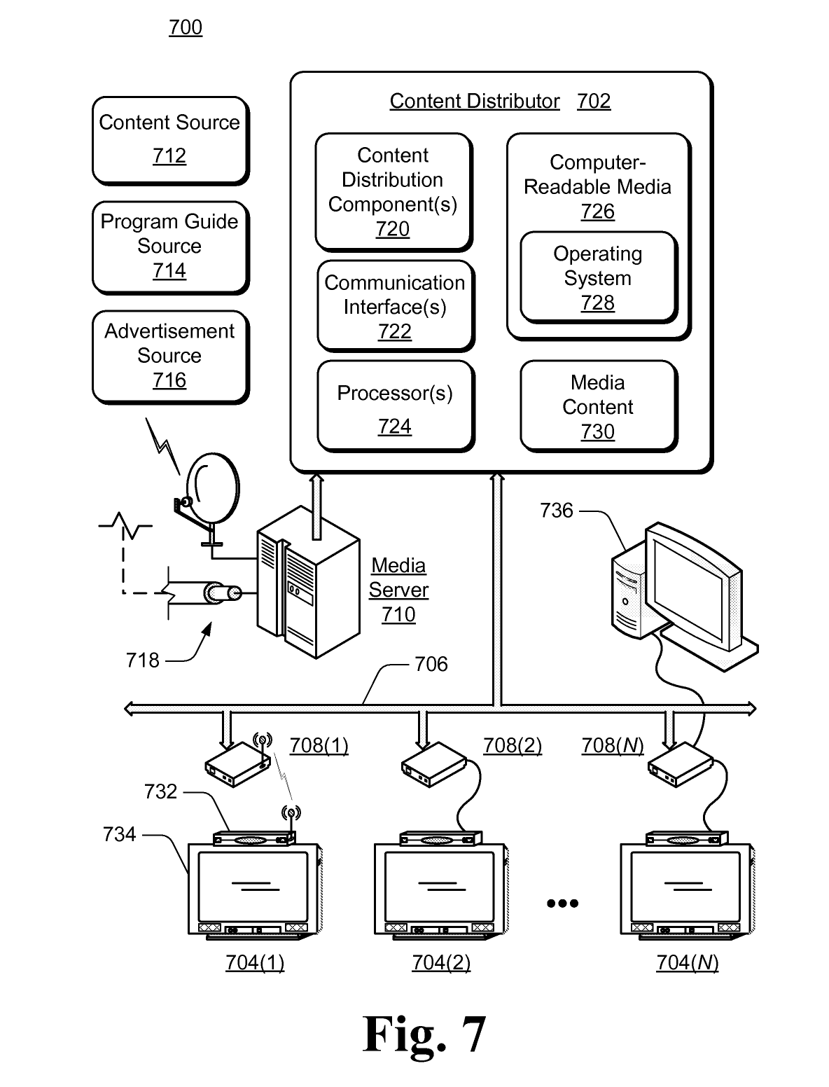

FIG. 7 illustrates an example entertainment and information system 700 in which one or more embodiments of advertising based on keywords in media content can be implemented. System 700 facilitates the distribution of media content, program guide data, and advertising content to multiple viewers and to multiple viewing systems. System 700 includes a content distributor 702 and any number “N” of client systems 704(1-N) each configured for communication via a communication network 706. Each client system 704(1-N) is an example of the client systems 508(1-N) described with reference to FIG. 5. Each of the client systems 704(1-N) can receive data streams of media content, media content, program guide data, advertising content, closed captioning data, and the like from content server(s) of content distributor 702 via communication network 706.

Communication network 706 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 706 can be implemented using any type of network topology and any network communication protocol, and can be represented or otherwise implemented as a combination of two or more networks. A digital network can include various hardwired and/or wireless links 708(1-N), routers, gateways, and so on to facilitate communication between content distributor 702 and client systems 704(1-N).

System 700 includes a media server 710 that receives media content from a content source 712, program guide data from a program guide source 714, and advertising content from an advertisement source 716. This advertising content can be the advertising content associated with the triggers as discussed above, and/or different advertising content presented to users of system 700. In one or more embodiments, media server 710 represents an acquisition server that receives the audio and video media content from content source 712, an EPG server that receives the program guide data from program guide source 714, and/or an advertising management server that receives the advertising content from the advertisement source 716.

Content source 712, program guide source 714, and advertisement source 716 control distribution of the media content, the program guide data, and at least some of the advertising content to the media server 710 and/or to other servers. The media content, program guide data, and advertising content can be distributed via various transmission media 718, such as satellite transmission, radio frequency transmission, cable transmission, and/or via any number of other wired or wireless transmission media. In this example, media server 710 is shown as an independent component of system 700 that communicates the media content, program guide data, and advertising content to content distributor 702. In an alternate implementation, media server 710 can be implemented as a component of content distributor 702.

Content distributor 702 is representative of a headend service in a content distribution system, for example, that provides the media content, program guide data, and advertising content to multiple subscribers (e.g., the client systems 704(1-N)). Content distributor 702 can be implemented as a satellite operator, a network television operator, a cable operator, and the like to control distribution of media content, program and advertising content, such as movies, television programs, commercials, music, and other audio, video, and/or image content to client systems 704(1-N).

Content distributor 702 includes various content distribution components 720 to facilitate media content processing and distribution, such as a subscriber manager, a device monitor, and one or more content servers. The subscriber manager manages subscriber data, and the device monitor monitors client systems 704(1-N) (e.g., and the subscribers), and maintains monitored client state information.

Although the various managers, servers, and monitors of content distributor 702 (to include media server 710 in one or more embodiments) are described as distributed, independent components of content distributor 702, any one or more of the managers, servers, and monitors can be implemented together as a multi-functional component of content distributor 702. Additionally, any one or more of the managers, servers, and monitors described with reference to system 700 can implement features and embodiments of advertising based on keywords in media content.

Content distributor 702 includes communication interface(s) 722 that can be implemented as any type of interface to communicate and receive data from client devices of the television system. Content distributor 702 also includes one or more processors 724 (e.g., any of microprocessors, controllers, and the like) which process various computer-executable instructions to control the operation of content distributor 702. Content distributor 702 can be implemented with computer-readable media 726 which provides data storage to maintain software applications such as an operating system 728 and media content 730 for distribution to the client systems 704(1-N).

Client systems 704(1-N) can each be implemented to include a client device 732 and a display device 734 (e.g., a television, LCD, and the like). A client device 732 of a respective client system 704 can be implemented in any number of embodiments, such as a set-top box, a digital video recorder (DVR) and playback system, an appliance device, a gaming system, and as any other type of client device that may be implemented in an entertainment and information system. In an alternate embodiment, client system 704(N) is implemented with a computing device 736 as well as a client device. The computing device 736 is an example of a connected data store that can record and maintain media content for a client device. Additionally, any client device 732 of a respective client system 704 can implement features and embodiments of advertising based on keywords in media content as described herein.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer-readable memory devices. The features of the advertising based on keywords in media content techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving compensation in exchange for associating advertising content with a keyword;
obtaining a trigger corresponding to the keyword, the trigger identifying both the keyword and one or more actions to be performed for presenting the advertising content; and
downloading the trigger to one or more consumer devices so that each of the one or more consumer devices can present the advertising content in response to the keyword occurring in media content being presented by the consumer device.

2. A method as recited in claim 1, the trigger further including criteria identifying particular media content that is to be presented in order for the advertising content to be presented.

3. A method as recited in claim 1, the trigger further including criteria identifying how frequently the one or more actions are to be performed.

4. A method as recited in claim 1, wherein the keyword occurring in the media content comprises the keyword occurring in metadata associated with the media content.

5. A method as recited in claim 4, wherein the metadata comprises closed captioning data.

6. A method as recited in claim 1, wherein the keyword comprises text.

7. One or more computer-readable media having stored thereon multiple instructions that, when executed by one or more processors, cause the one or more processors to:
access a trigger including both a criteria portion and a payload portion, the criteria portion identifying one or more criteria that includes a keyword, and the payload portion identifying one or more actions for presenting advertising content;
access data corresponding to media content being presented;
check whether the data satisfies the one or more criteria; and
perform the one or more actions in response to the data satisfying the one or more criteria.

8. One or more computer-readable media as recited in claim 7, the one or more criteria further identifying particular media content that is to be being played back in order for the one or more criteria to be satisfied.

9. One or more computer-readable media as recited in claim 7, the one or more criteria further identifying a time range that a current time is to be within in order for the one or more criteria to be satisfied.

10. One or more computer-readable media as recited in claim 7, wherein the data can satisfy the one or more criteria multiple times while the media content is being presented, and wherein the one or more criteria further identify how frequently the one or more actions can be performed while the media content is being presented.

11. One or more computer-readable media as recited in claim 7, the data corresponding to media content comprising closed captioning data.

12. One or more computer-readable media as recited in claim 7, wherein to perform the one or more actions is to display the advertising content.

13. One or more computer-readable media as recited in claim 12, wherein the instructions further cause the one or more processors to receive the trigger in response to compensation having been received for the trigger.

14. One or more computer-readable media as recited in claim 7, wherein the instructions further cause the one or more processors to:
access a second trigger including a second criteria portion and a second payload portion, the second criteria portion identifying additional one or more criteria that includes the keyword, and the second payload portion identifying an additional one or more actions;
access the data corresponding to media content being presented;
check whether the data satisfies the additional one or more criteria; and
perform the additional one or more actions in response to the data satisfying the additional one or more criteria.

15. A device comprising:
a trigger store to store multiple triggers, each of the multiple triggers comprising a criteria portion and a payload portion, the criteria portion identifying one or more criteria and the payload portion identifying one or more actions for presenting advertising content, the one or more criteria including a keyword; and
a monitor module, coupled to the trigger store, to monitor data corresponding to media content being presented and detect when the data satisfies the one or more criteria of one or more of the multiple triggers.

16. A device as recited in claim 15, wherein the data can satisfy the one or more criteria multiple times while the media content is being presented, and wherein the one or more criteria further identify how frequently the one or more actions can be performed while the media content is being presented.

17. A device as recited in claim 15, the data corresponding to media content comprising closed captioning data.

18. A device as recited in claim 15, wherein the monitor module is further to perform the one or more actions for presenting advertising content in response to detecting that the data satisfies the one or more criteria, the one or more actions comprising displaying the advertising content.

19. A device as recited in claim 15, wherein the trigger store is to receive one or more of the multiple triggers in response to compensation having been received for the one or more triggers.

20. A device as recited in claim 15, wherein the data corresponding to the media content comprises closed captioning data.
